(19) United States
(12) Patent Application Publication
(10) Pub. No.: US 2025/0140954 A1
(43) Pub. Date: May 1, 2025

(54) Electric Energy Storage Device, and Motor Vehicle

(71) Applicant: Bayerische Motoren Werke Aktiengesellschaft, Muenchen (DE)

(72) Inventors: Azad DARBANDI, Fraunberg (DE); Markus POETZINGER, Muenchen (DE)

(21) Appl. No.: 18/692,865

(22) PCT Filed: Sep. 8, 2022
(86) PCT No.: PCT/EP2022/074993

§ 371 Date: Mar. 18, 2024

(30) Foreign Application Priority Data
Oct. 5, 2021 (DE) 10 2021 125 751.4

(51) Int. Cl. H01M 10/48; H01M 50/209; H01M 50/213; H01M 50/503; H01M 50/509; H01M 50/569; H01M 50/583

(52) U.S. Cl. CPC H01M 10/482; H01M 50/209; H01M 50/213; H01M 50/503; H01M 50/509; H01M 50/569; H01M 50/583; H01M 2200/103; H01M 2220/20

(57) ABSTRACT

An electric energy storage device including a plurality of energy storage cells that are interconnected along system current paths, wherein parallel current paths and measurement connections having a lower current-carrying capacity than the system current paths are formed between the system current paths. The measurement connections are used for measuring voltages.

### FIELD

The invention relates to an electrical energy storage device and to a motor vehicle having such an energy storage device.

### BACKGROUND AND SUMMARY

Energy storage devices may have a plurality of energy storage cells, each of which is designed to store electrical energy. As an alternative to large energy storage cells, which alone or at least in a group of only a few energy storage cells can provide the energy supply of a motor vehicle, it can often be expedient to use numerous energy storage cells, which can be smaller in comparison and thus enable better utilization of installation space. Typically, parallel and series connections are used to increase the storage capacity and/or increase the output voltage.

In the case of known embodiments, system current and parallel current typically share the same electrical path. Parallel currents arise in particular due to slightly differing internal electrical resistances of energy storage cells connected in parallel. This is advantageously equalized by parallel currents. System currents are typically those currents that are conducted to the outside and flow through a load.

It is an object of the invention to provide an electric energy storage device that is of an alternative or better design compared to known embodiments. It is also an object of the invention to provide a motor vehicle having such an energy storage device. This is achieved, according to the invention, by an electric energy storage device and by a motor vehicle according to the respective main claims. The dependent claims represent preferred designs.

The invention relates to an electric energy storage device, which has a plurality of energy storage cells. Some of the energy storage cells are electrically connected in series along a first system current path, and some of the energy storage cells are electrically connected in series along a second system current path. Each system current path has a current-carrying capacity. Each system current path is formed by a plurality of connection sites, wherein each connection site connects a pole of one energy storage cell to a pole of a further energy storage cell in the system current path. Only one or more parallel current paths and measurement connections are formed between the system current paths. Each parallel current path extends between a connection site of a system current path and a connection site of another system current path. Each measurement connection extends between a connection site of a system current path and a connection site of another system current path. Each parallel current path expediently has a lesser current-carrying capacity than each system current path. Each measurement connection expediently has a lesser current-carrying capacity than each system current path. The energy storage device expediently has at least one voltage measuring device that measures a voltage between a first measurement site and a second measurement site, wherein at least one measurement site is arranged on a measurement connection.

Such an electric energy storage device can be used to ensure that malfunctions in individual energy storage cells, that in known designs can result in particularly high parallel currents, do not damage energy storage cells of other system current paths. A malfunction, for example in the form of a short circuit in an energy storage cell, thus remains limited to this energy storage cell.

It also becomes possible to measure a voltage by means of the voltage measuring device. One or more measurement connections can be used in this case as a measurement site. In particular, the measurement connections may be designed in such a way that, even in the event of a melt-through, they typically retain contact from the measurement site to at least one system current path. More generally, the measurement connections can be used to achieve controlled melt-through in the event of an overload, with a reduced current-carrying capacity compared to the system current paths. This enables voltage measurement even in the event of a fault.

In principle, in a modification, only one parallel current path may have a lesser current-carrying capacity than one, some or all system current path(s), or some parallel current paths may have a lesser current-carrying capacity than one, some or all system current path(s).

In principle, in a variation, only one measurement connection may also have a lesser current-carrying capacity than one, some or all system current path(s), or some measurement connections may have a lesser current-carrying capacity than one, some or all system current path(s).

The currents that flow in system current paths are typically those that are conducted outside of the energy storage device and flow through loads there, for example through an electric motor to drive a motor vehicle. Parallel current paths are current paths in which currents typically flow between energy storage cells, or between system current paths, due to slightly differing internal resistances, such parallel currents typically being relatively low. However, if an energy storage cell is short-circuited or has a thermal fault, such parallel currents can assume very large values and therefore become dangerous. This is precisely what is prevented by the technology disclosed here, namely due to the lesser current-carrying capacity of the parallel current paths.

A thermal fault is usually a fault in which an exothermic chemical reaction occurs. Such a fault may also be a thermal runaway event. In particular, the fault may be an event that causes operationally improper and self-aggravating production of heat in the individual cells. Under certain circumstances, propagation could occur. Such a fault may be caused, for example, by an internal short circuit in an individual cell or by a source of fire.

System current paths are separate from each other, apart from the parallel current paths and measurement connections. An exception to this may be common connection elements at the ends of the system current paths. These are then not considered part of the system current paths; they typically connect terminal connections of energy storage cells of the same polarity. Typically, each system current path connects only energy storage cells that are not connected by any other system current path, or do not belong to any other system current path. In particular, along a system current path, in each case a positive pole of one energy storage cell may be connected to a negative pole of the next energy storage cell in the system current path, or vice versa. This corresponds to a series connection of the energy storage cells. The voltages of the energy storage cells thus typically add up along the system current path, such that a higher output voltage is achieved.

In particular, a connection is to be understood here to mean an electrical connection.

The parallel current paths may in particular connect to one another connection sites that are arranged on the same side, or at adjacent longitudinal ends, of energy storage cells. The same applies to the measurement connections. Typically, a connection site connects exactly one pole of an energy storage cell with exactly one pole of a further energy storage cell.

In particular, it may be provided that all system current paths have the same current-carrying capacity. It may also be provided that all parallel current paths have the same current-carrying capacity and/or that all measurement connections have the same current-carrying capacity. In particular, there may also be deviations in the case of the parallel current paths, for example at or adjacent to discontinuities.

The connection sites may be formed by suitable connection means such as, for example, plates, wires or other electrical conductors. Their design typically defines the current-carrying capacity of the system current paths. Each connection site typically connects two poles of energy storage cells that are interconnected in succession along the respective system current path, in particular poles of differing polarity.

A current-carrying capacity is typically the maximum current that can flow along a current path, in particular without the current flow being interrupted. The current-carrying capacity of a system current path may be defined, in particular, by the connection sites, or their design. In particular, the connection sites of a current path may have an identical current-carrying capacity, which then represents the current-carrying capacity of the system current path. However, the connection sites may also have differing current-carrying capacities, in which case, for example, the lowest current-carrying capacity among the connection means may define the current-carrying capacity of the system current path.

The electric energy storage device is, in particular, a device for storing electrical energy, in particular for driving at least one electric (traction) drive machine. The energy storage device comprises a plurality of energy storage cells that are each formed as individual cells, and typically a multiplicity of such individual cells, which form the electrochemical energy storage cells. As a rule, a multiplicity of individual cells are provided. For example, the energy storage device may be a high-voltage storage device, or a high-voltage battery.

Typically, the energy storage device comprises at least one storage housing. The storage housing is expediently an enclosure that surrounds at least the high-voltage components of the energy storage device. Expediently, the storage housing is gas-tight, such that any gases escaping from the storage cells are trapped. Advantageously, the housing may serve to provide fire protection, contact protection, intrusion protection and/or protection against moisture and dust.

The storage housing may be produced, at least partially, from a metal. In particular, it may be made of aluminum, an aluminum alloy, steel or a steel alloy. At least one or more of the following components may be accommodated in the at least one storage housing of the energy storage device: energy storage cells, power electronics components, contactor(s) for interrupting the power supply to the vehicle, cooling elements, electric conductors, control device(s). In particular, the energy storage device may can have elements to be cooled, in particular energy storage cells and/or power electronics components of the energy storage device. Expediently, the components are pre-assembled before the assembly is installed in the vehicle.

In particular, the energy storage cells may be in the form of round cells for the electrochemical storage of energy. A round cell is usually accommodated in a cylindrical cell can. If the active materials of the round cell expand during operation, the housing is subjected to tensile stress in the surrounding region. Comparatively thin housing cross-sections can therefore advantageously compensate the forces resulting from the swelling. The cell housing is preferably produced from steel or a steel alloy.

Typically, degassing openings may be provided in the energy storage cells to allow gases to escape from the cell housing. However, there may also be only one degassing opening per storage cell, or round cell. Advantageously, there is at least one degassing opening arranged per round cell to degas toward the outer sill when in the installed position.

Preferably, the length-to-diameter ratio of the energy storage cells, or round cells, has a value of between 5 and 30, preferably between 7 and 15, and particularly preferably between 9 and 11. The length-to-diameter ratio is the quotient of the length of the cell housing of the round cell in the numerator and the diameter of the cell housing of the round cell in the denominator. In a preferred design, the round cells may, for example, have an (outer) diameter of approximately 45 mm to 55 mm. Further, advantageously, the round cells may have a length of 360 mm to 1,100 mm, preferably of approximately 450 mm to 600 mm, and particularly preferably of approximately 520 mm to 570 mm.

It may be provided that the round cells are produced from coated semi-finished electrode products. Expediently, the cathode material, or the anode material, is in each case applied to substrate layers, or substrate layer webs, of the respective semi-finished electrode product. For example, the cathode material may be applied to a cathode substrate layer (e.g. aluminum), and the anode material to an anode substrate layer (e.g. copper) by coating.

It may be provided that the round cells comprise at least one coated semi-finished electrode product, which does not have a mechanical separation edge perpendicular and/or parallel to the longitudinal axis of the round cells, which was produced by a separation process step after the coating of the semi-finished electrode products.

It may be provided that the energy storage cells, or round cells, each comprise at least one coated semi-finished electrode product having a rectangular cross-section, the length of the longer side of the semi-finished electrode product substantially corresponding to or exceeding a total width of a substrate layer web which was coated with anode material or cathode material to form the semi-finished electrode product, such that the semi-finished electrode product can be wound or was able to be wound in the longitudinal direction of the substrate layer web after the coating, without a further separation process step.

The energy storage cells, or round cells, in their installed position, are preferably substantially parallel (i.e. parallel, possibly with deviations that are insignificant for the function) to the vehicle transverse axis Y. The vehicle transverse axis is the axis that runs perpendicularly to the vehicle longitudinal axis X and horizontally when the motor vehicle is in the normal position. However, the energy storage cells may also run parallel to the vehicle longitudinal axis X. They may also be arranged differently.

The energy storage cells are typically arranged in a plurality of layers within the storage housing, in the direction of the vehicle vertical axis Z. The vehicle vertical axis in this case is the axis that extends perpendicularly to the vehicle longitudinal axis X and vertically when the motor vehicle is in the normal position. In particular in this case, a layer of energy storage cells is a multiplicity of energy storage cells that are installed in the same plane in the storage housing and are substantially at the same distance from the base of the storage housing. Advantageously, the number of layers varies in the direction of the vehicle longitudinal axis X. According to one possible embodiment, the storage housing may have an upper side, the outer housing contour of which is matched to the lower inner contour of a passenger compartment of the motor vehicle, the total height of the plurality of layers in the installed position being varied in the direction of the vehicle longitudinal axis for the purpose of adaptation to the housing contour in that, in a first region of a layer, directly adjacent round cells of the layer in the installed position are mutually spaced further apart in the direction of the vehicle longitudinal axis than directly adjacent round cells in a second region of the same layer, such that, advantageously, in the first region a further round cell of another layer extends further in a first intermediate region formed by the round cells directly adjacent in the first region than an identically formed further round cell of the other layer, which extends in a second intermediate region formed by round cells directly adjacent in the second region. The total height of the plurality of layers is measured from the base of the storage housing to the upper end of the uppermost layer at the respective site in the storage housing. The inner contour of the passenger compartment is the contour that delimits the interior of the passenger compartment accessible to a vehicle user. In particular, the housing contour may be adapted to the inner contour in such a way that an expediently constant gap, which is preferably less than 15 cm or less than 10 cm or less than 5 cm, is provided between the upper side of the storage housing and the inner contour of the passenger compartment.

When the energy storage device is in the installed position, at least one lowermost layer of the plurality of layers device may extend, in the direction of the vehicle longitudinal axis, from a front foot region of the storage housing adjoining the front footwell of the motor vehicle in the installed position to a seat region of the storage housing, the seat region adjoining the rear seat bench of the motor vehicle.

There may be fewer layers arranged in at least one of the foot regions of the storage housing adjoining the front or rear footwell of the motor vehicle than in a seat region of the storage housing, the seat region adjoining the front seats and/or the rear seats (for example individual seats or rear bench seat) of the motor vehicle. Advantageously, it may therefore be provided that, for example, only one lowermost layer of energy storage cells is provided in the storage housing in the front and/or rear foot region, whereas a plurality of layers are provided, stacked on top of each other, in the front and/or rear seat region. This has the advantage that, in particular, the installation space beneath the front seats, or beneath the rear seats can be utilized more efficiently in order thus to improve the electrical storage capacity of the motor vehicle.

It may be provided in one design that the plurality of energy storage cells of a layer are connected to each other by an adhesive applied over the plurality of energy storage cells of the same layer. Expediently, the adhesive may be applied only after the individual energy storage cells of a layer have been positioned relative to one another, for example after the energy storage cells have been arranged in the storage housing. Advantageously, the individual energy storage cells of a layer may thus be fixed relative to each other in a cost-effective and space-saving manner. Polyurethane, polyamide or polyethylene, for example, may be used as the adhesive.

Cooling elements for cooling the energy storage cells, which may preferably be at least partially corrugated in cross-section perpendicular to the transverse axis Y of the vehicle, may be provided between at least two layers of the energy storage cells. In one design, the cooling elements may be connected to a cooling circuit of the motor vehicle.

The current paths described here are realized in particular by suitable connections of the energy storage cells. In particular, this may mean that suitable conductive materials are used along a current path in order to connect the poles of the energy storage cells to each other. Typically in this case, respectively a positive and a negative pole of energy storage cells connected in succession in the system current path are connected along a system current path. Along a parallel current path, poles of the same polarity are typically connected to each other. In particular, connections between poles of differing polarity may also be interconnected, i.e. each connection, or connection site, connects a positive pole to a negative pole along the system current path, and a parallel current path connects at least two such connection sites. Typically, a parallel current path is therefore formed between two connections, or connection sites, each of the connections, or connection sites, along a respective system current path connecting opposite poles of energy storage cells to each other.

The current paths or their connection sites, are realized in particular by connections, connection elements, or connection plates, that are arranged outside of the energy storage cells. They may also be integral with the energy storage cells.

The parallel current paths may be provided, in particular, on both sides, or at both longitudinal ends and/or opposite poles, of the energy storage cells. In particular, they may be provided between equivalent sites or voltages in the system current paths. Parallel currents may thus flow not only between connection sites, but also through energy storage cells and, for example in this case, also through a total of two parallel current paths.

The first measurement site may in particular be arranged on a first measurement connection, and the second measurement site may in particular be arranged on a second measurement connection. This makes it possible to utilize the advantageous effect of the measurement connections on both sides.

Alternatively, there may be only one measurement site arranged on a measurement connection, and there may be another measurement site arranged, for example, within a system current path and/or on a connection site. The number of measurement connections required can thus be reduced.

Preferably, one, some or all measurement sites arranged on a measurement connection is/are arranged between two system current paths. This allows the system current paths always to remain independent of the respective measurement site and to be used for current conduction, but at the same time a measurement based on both system current paths is possible.

A measurement site may be understood in particular as a point or another, in particular small, geometrically delimitable site at which a voltage measurement can be effected. For this purpose, such a measurement site is typically connected to the voltage measuring device.

Particularly advantageously, the measurement connections are designed to melt away on both sides of the measurement site when their current-carrying capacity is exceeded. It can thereby be achieved, in particular, that no electrical connection remains on either side. The measurement site that is no longer connected may then be recognized, for example, in order to detect a fault. The measurement site, or a connection line to the voltage measuring device may, for example, drop downward. In particular, the measurement site may assume an undefined potential.

In particular, the measurement connections may be designed to leave no electrical connection between the measurement site and any of the system current paths once their current-carrying capacity has been exceeded. This achieves the advantages already described.

In particular, one, some or all measurement connections may be in the form of ribbon cables. This has proven to be a simple and expedient design. In particular, a ribbon cable may have a constant or at least partially constant cross-section. However, other designs are also possible.

Advantageously, one, some or all measurement connections may have a narrowing. In particular, the measurement site may be applied on the narrowing. The current-carrying capacity may thus be defined by means of the narrowing.

The voltage measuring device may be configured in particular to recognize an interruption of a parallel current path. It is thereby possible not only to realize a voltage measurement but also to determine a fault.

According to a preferred embodiment, each parallel current path and/or each measurement connection has a current-carrying capacity of at most 20 A. The parallel current paths and/or measurement connections may also have a current-carrying capacity of at most 15 A or at most 25 A. A current-carrying capacity of between 15 A and 25 A may also be provided. This applies separately to each parallel current path and/or each measurement connection. The current-carrying capacity of a parallel current path is typically the value up to which a current can flow along a respective parallel current path. If this current is exceeded, the design of the parallel current path, or the materials used, for it typically ensure(s) that a further current flow or at least a further increase in the current is no longer possible. The same applies to the measurement connections.

In particular, one, some or all measurement connections may have a lesser current-carrying capacity than a parallel current path that is parallel thereto. It can thus be ensured that the parallel current path is first melted through, or interrupted, and only then is the measurement connection melted through, or interrupted, such that the measurement connection is focused on its measurement functionality.

In particular, it may also be provided that each parallel current path and/or each measurement connection have/has a current-carrying capacity of at most 5% of the current-carrying capacity of each system current path. This may mean, in particular, that when comparing each parallel current path and/or each measurement connection with each system current path, the current-carrying capacity of the respective parallel current path or of the respective measurement connection has at most 5% of the current-carrying capacity of the respective system current path. Values other than 5% may also be used here, for example a maximum of 3% or a maximum of 7%. Such values have proven to be advantageous for typical applications, in particular in motor vehicles.

In particular, the parallel current paths may be implemented as fuses. In particular, this may mean that the respective parallel current path, or the electrical conductor forming the parallel current path, is implemented in such a way that if the current-carrying capacity is exceeded, heating is effected for a short time, which interrupts the parallel current path, or destroys the material forming the parallel current path at least along a certain portion. Further current flow along the parallel current path is then no longer possible.

In more general terms, the parallel current paths may in particular be designed to self-interrupt when the current-carrying capacity is exceeded. This means that if a current flows that exceeds the current-carrying capacity, the corresponding parallel current path, because of its design, interrupts itself and prevents the further flow of current. In particular, corresponding materials that form the parallel current paths may be designed accordingly.

In particular, the energy storage cells may be electrically connected along the system current paths and along the parallel current paths by electrically conductive connection plates. In particular, the connection sites and the parallel current paths may be formed by electrically conductive connection plates. Typically in this case, a connection plate forms two or more connection sites and parallel current paths in between. As mentioned, each connection site in this case connects two poles. A connection plate in this case may be formed with a largest possible cross-section along a connection site for good current-carrying capacity. In particular, a current-carrying capacity along a system current path, or a connection site, may have a value of at least 500 A or 1,000 A or of at most 1,500 A. However, other values are also possible, depending on the application. For a poorer current-carrying capacity, for example to form a parallel current path, a smaller cross-section, in particular, may be used. A connection plate in this case typically connects two energy storage cells along each system current path, and connects the system current paths along one or more parallel current paths.

In particular, the energy storage cells may be connected along the parallel current paths by electrically conductive webs. In particular, the parallel current paths may be formed by electrically conductive webs, in particular of the connection plates. These electrically conductive webs may, in particular, have a smaller and, in particular, significantly smaller cross-section than the connections along the system current paths. For example, they may have a cross-section that is at most 10%, at most 7%, at most 5% or at most 3% of the cross-sections of the connection sites, or along the system current paths. In particular, the webs may be formed as constituent parts of the aforementioned connection plates. This can be a simple way of ensuring that the parallel current paths have a lesser current-carrying capacity.

According to a preferred embodiment, connection sites are formed along each system current path, between terminal connections of energy storage cells, preferably two energy storage cells in each case, with differing polarity, the parallel current paths also being formed between at least two connection sites in each case. This allows a high current to flow along the system current paths, whereas only a limited current can flow along the parallel current paths. The connection sites may be formed, or realized, for example, with the connection plates already mentioned above. By means of corresponding connection plates, predefined combinations of system current paths and parallel current paths, in particular the wanted number of system current paths, may be taken into account. Thus, for example, different connection plates may be used depending on whether two, three or more layers of energy storage cells are used, and depending on how many system current paths are to be formed within these energy storage cells.

In particular, the longitudinal axes of the energy storage cells may be aligned parallel to each other. This enables a compact arrangement that can utilize existing installation space in an advantageous manner.

Connections, or connection sites, along a system current path typically alternate with respect to respective longitudinal ends of the energy storage cells. This may mean, for example, that connection sites of a system current path alternate between a left-hand side and a right-hand side of the vehicle (when the energy storage cells are installed transversely with respect to the vehicle longitudinal axis X) or alternate between the front and rear (when the energy storage cells are installed parallel to the vehicle longitudinal axis X).

In particular, the energy storage cells may be arranged in one, two, three or more layers. According to one possible embodiment, each system current path extends along one of the layers. This enables a simple embodiment and the use of identical connection elements, or connection plates, at least outside of interruptions such as those described in more detail below.

In principle, however, it is also possible to use only one layer. In this case, for example, all energy storage cells may have the same height when installed in a vehicle.

According to one embodiment, the energy storage cells are arranged in a first layer and a second layer. A first system current path, a second system current path and a third system current path may be provided in this case. Each system current path may extend along three directly adjacent energy storage cells of one layer, and then further along three directly adjacent energy storage cells of the other layer, which are spaced apart by one energy storage cell or by one and a half energy storage cells. In particular, the spacing in this case can be seen along a direction along which the energy storage cells of a respective layer are arranged next to each other, for example along a vehicle longitudinal axis X or a vehicle transverse axis Y, or in a horizontal plane if the motor vehicle is standing on a flat surface. In particular, the spacing may also be defined along a direction predefined by the system current paths. Such an embodiment has proven to be particularly advantageous if three system current paths are to be provided in an arrangement having two layers of energy storage cells. Standardized connection elements, or connection plates, that can be reused as often as required may be used.

A course of a system current path along a plurality energy storage cells of a layer typically means that the system current path extends along directly adjacent cells of this layer. The cells are connected to each other accordingly.

With regard to the course of system current paths described herein, it is to be noted that these may, in principle, be continued accordingly after the course indicated in each case, in which case the course typically again extends as described. The described courses may therefore be used as often as required in succession.

A spacing around an entire energy storage cell or a plurality of entire energy storage cells may occur, in particular, if energy storage cells of different layers are arranged directly above one another without their mid-points being offset from one another. If the cells of directly adjacent layers are offset from each other by half an energy storage cell, such that, for example, as viewed in cross-section, a mid-point of an energy storage cell of one layer lies below or above a centre between two mid-points of energy storage cells of a layer arranged directly above or below it, then in particular spacings of half an energy storage cell, one and a half energy storage cells, etc. may also occur.

According to one embodiment, the energy storage cells may be arranged in a first layer, a second layer and a third layer. The first system current path may extend alternately between two directly adjacent energy storage cells of the first layer and an energy storage cell of the second layer, and the second system current path may extend alternately between two directly adjacent energy storage cells of the third layer and an energy storage cell of the second layer. The respective energy storage cell of the second layer may in this case be arranged further along a direction as viewed along the extent of the layers, for example as viewed horizontally. An advantageous configuration with three layers and yet only two system current paths can thus be achieved, and even in this case a very limited number of connection elements, or connection plates, typically to be used between the energy storage cells is required. In particular, the second layer may be arranged between the first layer and the third layer.

According to one embodiment, one or more interruptions are formed in one or more layers. There are no energy storage cells present in an interruption. In other words, the distance between energy storage cells in a layer may be greater in an interruption than otherwise. The system current paths may bridge the interruption. This may mean, for example, that at least one or extends/of the system current paths extend at the side of the interruption. In this way, for example, energy storage cells that directly adjoin the interruption can be connected to each other. Adjoining each interruption, the course of the system current paths may deviate. Suitable connection elements, or connection plates, that can be used according to the number of layers, number of system current paths and size of the interruption may also be provided for this. In the case of an interruption, system current paths that would otherwise extend along a layer may, for example, cross over each other. In particular, connections, connection sites, connection elements, or connection plates, may be designed to extend at the side of an interruption, i.e. in particular at the respective longitudinal ends of the energy storage cells.

The energy storage cells may be connected to each other at their longitudinal ends, in particular by means of one type or a plurality of different types of connection plates. In particular, one, two or three different types of connection plates are sufficient for most embodiments, as will be explained in more detail below with reference to the drawings. Such connection plates may be designed, in particular, for a corresponding configuration of layers and system current paths, as well as for any interruptions. This makes it possible to produce suitable electrical connections over any extent with a very limited number of connection plates. As described in more detail below with reference to the drawing, one type of connection plate is sufficient for simple embodiments. For more complex embodiments and/or interruptions, for example, two, three or four different types of connection plates may be used. More generally, the connection plates may also be referred to as cell connectors.

The connection plates may be flat, but they may also be bent or have a different shape. They may have a constant thickness, but may also have a non-constant thickness.

According to one embodiment, the energy storage cells are in the form of round cells. According to an alternative embodiment, the energy storage cells are in the form of prismatic cells. In these cases in particular, the concept described herein may be used to utilize parallel current paths and measurement connections with significantly lesser current-carrying capacity compared to the system current paths.

The invention also relates to a motor vehicle having an energy storage device as described herein. With respect to the energy storage device, any of the embodiments and variants described herein may be used.

In other words, there are typically multiple parallel and series connections in an electrical storage system, such that, in the case of embodiment according to the prior art, system current and parallel current typically share the same electrical path. Parallel currents typically result from slightly differing internal electrical resistances of energy storage cells connected in parallel.

In the case of a thermal event in an energy storage cell, or battery cell, the respective cell may become low-resistance, or is short-circuited internally. In such a situation, it may happen that all cells connected in parallel are also short-circuited by the low-resistance cell. Such a short-circuit event (in cells connected in parallel) may place additional thermal load on these cells, causing the cell temperature to rise. This increases the risk of a further thermal event in the already short-circuited cell.

Cell connection concepts are therefore proposed herein that make it possible to separate the parallel current path from the system current path. In particular, the parallel current path is presented having a considerably lesser current-carrying capacity, such that, in the event of a short-circuit current between cells connected in parallel, this parallel current path serves as a fuse, and a persistent short-circuit situation is thus suppressed, or prevented.

In order to always be able to monitor the voltage of all cells, even if a parallel current path is not functioning, a new type of voltage tap may be provided, which suppresses the electrical interfacing to the cell connector in the event of a (mechanically or thermally) damaged P-fuse. This causes the measuring channel in a battery management unit to trigger a fault, and a storage defect can be detected immediately. This eliminates the risk of overcharging, or deep discharging (and therefore a thermal event).

A ribbon cable may be provided that has an inherent narrowing. In the event of a damaged P-fuse, the parallel currents are compensated via ribbon cable. Since the ribbon cable has an extremely lesser current-carrying capacity than necessary for parallel currents, especially at the narrowing site, the narrowing site is melted through, and at the same time the electrical interfacing of the voltage tap to both cells is interrupted.

The technology described here is now described with reference to the accompanying drawings.

### BRIEF DESCRIPTION OF THE DRAWINGS

FIG. 1 shows an energy storage device according to the prior art,

FIG. 2 shows an illustration of system and parallel current paths in a particular embodiment, and

FIG. 3 shows an energy storage device according to the invention.

### DETAILED DESCRIPTION OF THE DRAWINGS

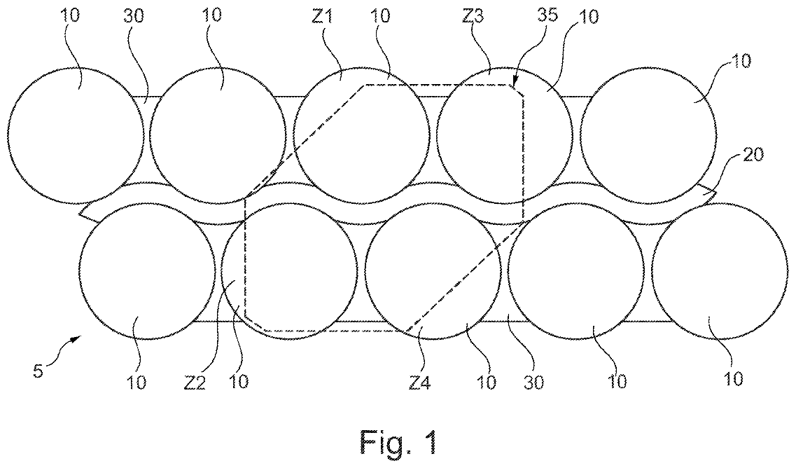

FIG. 1 shows an energy storage device 5 according to the prior art. This has a plurality of energy storage cells 10 that are in the form of elongate round cells. Electrical energy can be stored electrochemically in each of these cells.

FIG. 1 shows in this case a purely schematic side view, although the energy storage device 5 may also be of a greater or lesser extent.

As shown, the energy storage cells 10 are arranged in two layers, one above the other, of five energy storage cells 10 each. They extend transversely with respect to the plane of the paper FIG. 1 and are arranged parallel to each other with respect to their longitudinal axes. Located between them there is a corrugated cooling plate 20. In principle, in the embodiment shown, a respective system current path extends along a respective layer. However, not all the necessary connection elements are shown, but only an example of a connection element in the form of a connection plate 35 is shown, as is typically used in embodiments according to the prior art. The connection plate 35 is represented by a dashed line. As shown, it connects four energy storage cells, namely the energy storage cells Z1, Z3 of the upper layer and the energy storage cells Z2, Z4 of the lower layer. A positive pole and a negative pole are connected to each other along a respective system current path.

Due to the embodiment of the connection plate 35 shown, a system current path can flow along each of the two layers of energy storage cells 10, but a parallel current can also flow between the layers. In typical operation, this compensates for slightly differing internal resistances of the individual energy storage cells 10, which is a wanted effect of parallel currents.

To be considered now, as an example, is the case in which a short circuit occurs in the energy storage cell Z1. This can result in significant heating of the energy storage cell Z1, this also being referred to as a thermal event. As shown, arranged between the respective energy storage cells 10 of a layer there is a thermally insulating material 30 that prevents or slows down any propagation of the heating. In the case of the embodiment shown, however, it is possible that, for example, the energy storage cell Z2, which has the same polarity as the first energy storage cell Z1, suddenly discharges an increased current due to the short-circuiting of the energy storage cell Z1, and therefore also overheats. As a result, any thermal event may propagate through the energy storage device 5.

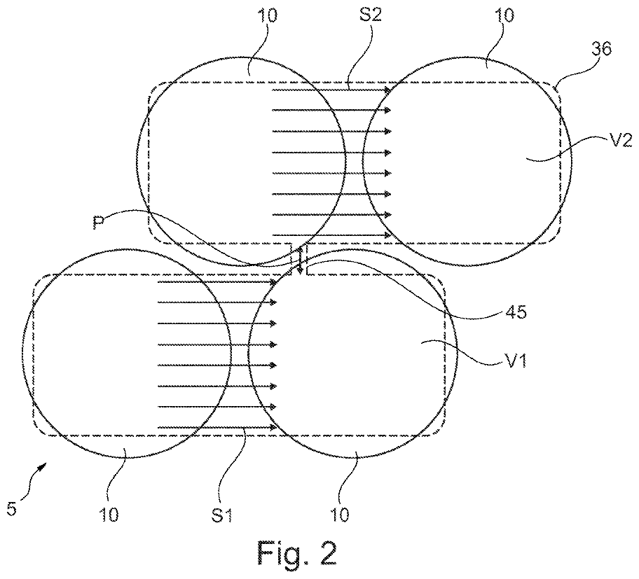

Shown purely schematically in FIG. 2 is an energy storage device 5 that has a total of four energy storage cells 10 represented to explain part of the concept described herein. Firstly, it can be seen that, according to the embodiment of a connection plate 36 used, two system current paths S1, S2 extend horizontally, i.e. along a respective layer of energy storage cells 10. These are each represented here by a plurality of arrows. In the present embodiment, two adjacent energy storage cells 10 are each connected along a system current path S1, S2. Such a connection may be referred to as a connection site, there being a first connection site V1 in the first system current path S1 and a second connection site V2 in the second system current path S2. Between two such connection sites V1, V2 there is a parallel current path P that, as already mentioned, serves to equalize any slightly differing internal resistances. This is a desirable effect in normal operation. However, in the event of a short-circuit in one of the energy storage cells 10, this would no longer be desirable, as already explained with reference to FIG. 1.

In the present case, therefore, the parallel current path P is designed so that it only has a significantly lesser current-carrying capacity than the system current paths S1, S2. This is achieved by making the parallel current path P significantly thinner than the system current paths S1, S2, the parallel current path P in the present case being realized as a web 45. Thus, if a short circuit were to occur in one of the energy storage cells 10, the material provided for the parallel current path P in the web 45 would melt as soon as the current-carrying capacity of the parallel current path P is exceeded. The parallel current path P would then no longer be available. The electrical connection is thus interrupted, and further propagation of a thermal event across the energy storage cells 10 of the energy storage device 5 is no longer possible.

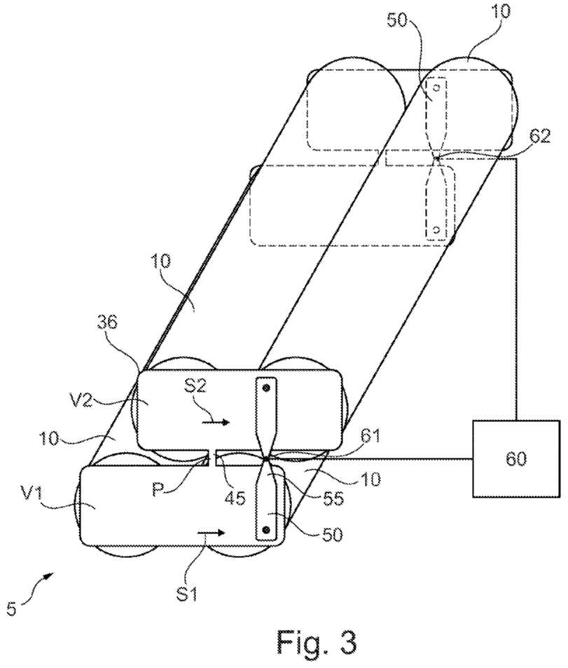

FIG. 3 shows a purely schematic perspective view of an energy storage device 5 according to an exemplary embodiment. In addition to the components already represented in FIG. 2, here there is a measurement connection 50. This extends parallel to the parallel current path P and is formed by a ribbon cable. The ribbon cable is fastened to the two connection sites V1, V2 as shown.

The measurement connection 50 has a narrowing 55, arranged centrally between the two connection sites V1, V2. This defines the current-carrying capacity. In particular, the measurement connection 50 has a lesser current-carrying capacity than the web 45, such that the functionality already described with reference to FIG. 2 is not impaired.

The energy storage device 5 additionally has a voltage measuring device 60. This is connected to a first measurement site 61 and a second measurement site 62. The first measurement site 61 in this case is arranged on the measurement connection 50 just described, namely centrally between the connection sites V1, V2 and on the narrowing 55 already described.

The second measurement site 62 is arranged in an equivalent manner on a further measurement connection 50 at the opposite longitudinal ends of the energy storage cells 10. The following explanations for the first measurement site 61 apply accordingly.

In the event of the parallel current exceeding the current-carrying capacity of the parallel current path P, the web 45 would first melt through. A parallel current could then only flow via the measurement connection 50, which would also melt through accordingly. Due to the design of the measurement connection 50, this would happen in such a way that melting would occur on both sides of the first measurement site 61, such that the first measurement site 61 would not remain connected to either of the two connection sites V1, V2.

Since the second measurement site 62 is also designed accordingly, the measurement sites 61, 62 are at an undefined potential after the measurement connections 50 have melted through. This may be used for fault detection.

In particular, the need for separate measurement sites or separate voltage measuring devices for the system current paths can be eliminated by the embodiment described. As a result, effort and costs can be saved overall.

For reasons of readability, the term “at least one” has been partially omitted for the sake of simplicity. If a feature is described in the singular, or indefinitely (e.g. the/one energy storage cell, the/one connection element, etc.), it is intended to also disclose the plurality thereof (e.g. the at least one energy storage cell, the at least one connection element, etc.).

The foregoing description of the present invention is for illustrative purposes only and not for the purpose of limiting the invention. Within the scope of the invention, various changes and modifications are possible without departure from the scope of the invention and its equivalents.

### LIST OF REFERENCE DESIGNATIONS

5: energy storage device
10: energy storage cell
20: cooling plate
30: thermally insulating material
35: connection plate
36: connection plate
45: web
50: measurement connection
55: narrowing
60: voltage measuring device
61 first measurement site
62: second measurement site
S: system current paths
P: parallel current paths
V: connection sites

1-16. (canceled)

17. An electric energy storage device, comprising:
a plurality of energy storage cells, wherein some of the energy storage cells are electrically connected in series along a first system current path, and some of the energy storage cells are electrically connected in series along a second system current path,
wherein each system current path is formed by a plurality of connection sites, wherein each connection site connects a pole of one energy storage cell to a pole of a further energy storage cell in the system current path,
wherein one or more parallel current paths and measurement connections are formed between the system current paths, wherein each parallel current path extends between a connection site of the first system current path and a connection site of the second system current path,
wherein each parallel current path has a lesser current-carrying capacity than each system current path, and each measurement connection has a lesser current-carrying capacity than each system current path, and
wherein the energy storage device comprises at least one voltage measuring device configured to measure a voltage between a first measurement site and a second measurement site, wherein at least one of the first or second measurement sites is arranged on at least one of the measurement connections.

18. The energy storage device according to claim 17, wherein the first measurement site is arranged on a first measurement connection, and the second measurement site is arranged on a second measurement connection.

19. The energy storage device according to claim 17, wherein one, some, or all measurement sites arranged on a measurement connection is/are arranged between two system current paths.

20. The energy storage device according to claim 17, wherein each measurement connection is configured to melt away on both sides of the measurement site when their current-carrying capacity is exceeded.

21. The energy storage device according to claim 17, wherein each measurement connection is designed to leave no electrical connection between the measurement site and any of the system current paths once their current-carrying capacity has been exceeded.

22. The energy storage device according to claim 17, wherein one, some, or all of the measurement connections is/are in the form of ribbon cables.

23. The energy storage device according to claim 17, wherein one, some, or all of the measurement connections comprise a narrowing, and wherein the measurement site is applied on the narrowing.

24. The energy storage device according to claim 17, wherein the voltage measuring device is configured to recognize an interruption of a parallel current path.

25. The energy storage device according to claim 17, wherein each parallel current path and each measurement connection has a current-carrying capacity of between 15 A and 25 A.

26. The energy storage device according to claim 17, wherein one, some, or all of the measurement connections has/have a lesser current-carrying capacity than a parallel current path that is parallel thereto.

27. The energy storage device according to claim 17, wherein each parallel current path and each measurement connection has a current-carrying capacity of at most 5% of a current-carrying capacity of each system current path.

28. The energy storage device according to claim 17, wherein the parallel current paths are implemented as fuses and/or configured to self-interrupt when their current-carrying capacity is exceeded.

29. The energy storage device according to claim 17, wherein the connection sites and the parallel current paths are formed by electrically conductive connection plates, and/or wherein the parallel current paths are formed by electrically conductive webs.

30. The energy storage device according to claim 17, wherein the energy storage cells are connected to each other at their longitudinal ends by three or less different types of connection plates.

31. The energy storage device according to claim 17, wherein the energy storage cells are in the form of round cells and/or prismatic cells.

32. A motor vehicle comprising:
the energy storage device according to claim 17.
